(19) United States
(12) Patent Application Publication
(10) Pub. No.: US 2026/0087463 A1
(43) Pub. Date: Mar. 26, 2026

(54) MANAGEMENT APPARATUS, MANAGEMENT METHOD, AND PROGRAM

(71) Applicants: Kulture Inc., Tokyo (JP); AMUSE INC., Yamanashi (JP)

(72) Inventors: Kosuke SHIRAISHI, Tokyo (JP); Masafumi EDOHARA, Tokyo (JP); Yuki ABE, Tokyo (JP); Tatsuya FUJII, Tokyo (JP); Yusuke KOMINAMI, Tokyo (JP)

(73) Assignees: Kulture Inc., Tokyo (JP); AMUSE INC., Yamanashi (JP)

(21) Appl. No.: 19/337,647

(22) Filed: Sep. 23, 2025

(30) Foreign Application Priority Data
Sep. 24, 2024 (JP) 2024-165457

(51) Int. Cl. G06Q 50/00; G06Q 10/02; G06Q 20/36; G06V 30/41

(52) U.S. Cl. CPC G06Q 10/40; G06Q 10/028; G06Q 20/36; G06V 30/41

(57) ABSTRACT

There is provided a technique that enables direct communication between users participating in an event and between the users and the performer. There is provided a management apparatus comprising: a memory storing a program; and a processor that, by executing the program stored in the memory, is configured to: store event holding information related to a held event; manage a channel that is a communication tool opened for each performer and each event; acquire ticket information related to a ticket for the event possessed by a user, and compares the acquired ticket information with the event holding information, so as to confirm that the user possesses the ticket; and permit the user who has been confirmed to possess the ticket for the event and a performer of the event to make a post to the channel and view a post to the channel.

### CROSS-REFERENCE TO RELATED APPLICATION

The present application is based upon Japanese Patent Application No. 2024-165457, filed on Sep. 24, 2024, the disclosure of which is incorporated herein by reference.

### BACKGROUND OF THE INVENTION

### Field of the Invention

The present invention relates to a management apparatus, a management method and a program.

### Description of the Related Art

Currently, various events using real venues such as live performances and sports are held. Further, a ticket issuing system that, when issuing a ticket for an event, a concert, etc., can facilitate the receipt of the ticket has been disclosed (Japanese Patent Laid-Open No. 2017-027441).

By purchasing a ticket for an event and participating in the event, users can feel close to the performer. This kind of realistic experience is obtained only by users who actually participate in the event. Further, in order to enable users participating in an event to feel much closer to the performer and to shorten the distance between the users and the distance between the users and the performer, there is a need for a mechanism that enables direct communication between the users participating in the event and between the users and the performer.

Therefore, an object of the present invention is to provide a technique that enables direct communication between users participating in an event and between the users and the performer.

### SUMMARY OF THE INVENTION

A management apparatus comprising: a memory storing a program; and a processor that, by executing the program stored in the memory, is configured to: store event holding information related to a held event; manage a channel that is a communication tool opened for each performer and each event; acquire ticket information related to a ticket for the event possessed by a user, and compares the acquired ticket information with the event holding information, so as to confirm that the user possesses the ticket; and permit the user who has been confirmed to possess the ticket for the event and a performer of the event to make a post to the channel and view a post to the channel.

The present invention enables direct communication between users participating in an event and between the users and the performer.

### BRIEF DESCRIPTION OF THE DRAWINGS

FIG. 1 is a diagram showing an example of a communication management system according to the present embodiment;

FIG. 2 is a diagram showing an example hardware configuration of a management server;

FIG. 3 is a diagram showing an example functional block configuration of the management server;

FIG. 4 is a diagram showing an example of an event management DB;

FIG. 5 is a diagram showing an example of an account management DB;

FIG. 6 is a diagram showing an example of a ticket management DB;

FIG. 7 is a diagram showing an example of a channel management DB;

FIG. 8 is a diagram showing an example of a post management DB;

FIG. 9 is a diagram showing an example of a processing procedure performed by the management server;

FIG. 10 is a diagram showing an example of a processing procedure performed by the management server;

FIG. 11 is a diagram showing an example of screens for registering a ticket; and

FIG. 12 is a diagram showing an example of post display screens.

### DETAILED DESCRIPTION OF THE INVENTION

Embodiments of the present invention will be described with reference to the accompanying drawings. Note that in the figures, components with the same reference numeral have the same or similar configuration.

### <System Configuration>

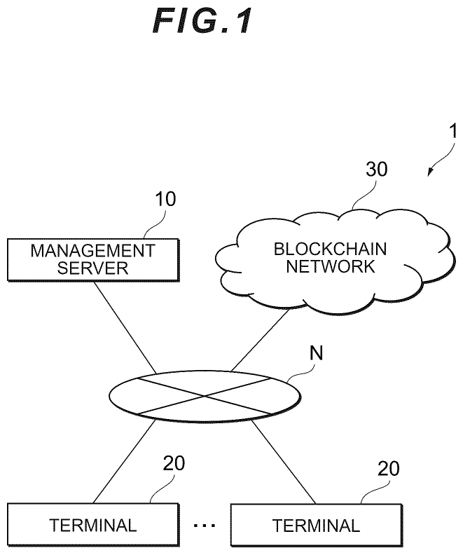

FIG. 1 is a diagram showing an example of a communication management system 1 according to the present embodiment. The communication management system 1 includes a management server 10 (also referred to as a management apparatus), one or more terminals 20, and a blockchain network 30. The management server 10, the one or more terminals 20, and the blockchain network 30 are connected over a wireless or wired communication network N, and can communicate with each other.

The communication management system 1 is a system that provides a service (hereinafter referred to as a “communication service”) enabling communication between the performer of an event and participants who purchase a ticket and participate in the event and between the participants who purchase a ticket and participate in the event. In the past, it has been possible for the performer of an event to convey messages to participants, for example, by offering information on SNSs or the like. However, since information offered on SNSs can be seen not only by event participants but also by a large number of unspecified people, there has been a problem that it is difficult to understand for whom the information is meant. Further, even when an event participant makes a post on an SNS, it can be seen not only by the performer but also by a large number of unspecified people, so there has been a problem that information known only to event participants is conveyed to a large number of unspecified people.

Therefore, the communication management system 1 according to the present embodiment makes it possible to provide a state in which the content of communication is disclosed to the outside or a state in which the content of communication is not disclosed to the outside, and enables direct communication between participants who have been confirmed to possess a ticket for participating in an event and the performer and between the participants who have been confirmed to possess a ticket.

In the following description, a user who uses the communication service is referred to as a user. Users include a performer of an event, related persons (a manager for the performer and people who run the event), and users other than the performer and the related persons (hereinafter referred to as “general users”). Further, when a performer among the users is referred to, they are written as a user (performer) or a performer. When a related person among the users is referred to, they are written as a user (related person) or a related person. Further, when a performer, related persons, and general users are not distinguished, they are simply written as “users”.

An “event” is an event in which a performer is present and those who possess a ticket for the event can participate. Specifically, events include live performances, concerts, performances, movies, plays, talk shows, sports games, e-sports games, etc. Note that “performance” means that a performer performs in a specific place for a specific period of time. Events may include events held online in addition to events held at real venues. Further, when a plurality of performances are given with the same title like a tour, an event may be a tour or a performance.

Further, among the general users, a user who has been confirmed to possess a ticket for participating in the event is referred to as a “ticket possessing user”, and a user who has not been confirmed to possess a ticket and a user who does not possess a ticket are referred to as “ticket non-possessing users”.

In the present embodiment, the management server 10 provides a tool (hereinafter referred to as a “channel”) that realizes two-way communication between the performer and the ticket possessing users on the Internet. The channel may be anything as long as it allows posting text, images, audio, video, etc. Channels include, for example, social media, bulletin boards, SNSs (Social Networking Services), and video sharing services.

A channel is opened for each performer and each event, and a performer, related persons, and ticket possessing users can post messages containing any text, images, videos, etc. For example, when there are an event X (e.g., a live performance X) held in Tokyo in which a performer A (e.g., an artist A) appears and an event Y (e.g., a live performance Y) held in Osaka in which a performer B (e.g., an artist B) appears, different channels are opened for them.

Note that when a plurality of performers appear in one event, a different channel may be opened for each performer, or a channel common to the plurality of performers may be opened. For example, when the same event X (e.g., a rock festival) in which performers A, B, and C appear is held, each of a channel for the performer A related to the event X, a channel for the performer B related to the event X, and a channel for the performer C related to the event X may be opened, or a channel common to the performers A-C related to the event X may be opened. Note that when the performer is a group of people, a channel may be opened for each performer or a channel may be opened for each group. Further, when a performer X conducts a tour Y in which a performance A, a performance B, and a performance C are given, one channel may be opened for each performer and each tour, such as a channel for the performer X and the tour Y, or a plurality of channels may be opened on a per-performer and per-performance basis, such as a channel for the performer X and the performance A, a channel for the performer X and the performance B, and a channel for the performer X and the performance C.

Further, the timing at which a channel is opened and the timing at which the channel ends may be determined freely. For example, a channel may be opened on the event start date or a predetermined number of days before the event start date and end a predetermined number of days after the event end date.

The management server 10 performs various processes related to the provision of channels. For example, the management server 10 manages the posting of messages on channels, manages accounts for using the communication management system 1, provides pages (web pages or pages displayed on an application screen) viewed by users, etc.

The terminals 20 are terminals used for accessing the management server 10, such as smartphones, tablet terminals, mobile phones, personal computers (PCs), and the like.

The blockchain network 30 executes a smart contract that manages NFTs (Non-Fungible Tokens). The management server 10 issues an NFT indicating participation in an event and grants it to a ticket possessing user. The NFT may be issued by the management server 10 for each performer and each event (i.e., for each channel) or for each event. A ticket possessing user can prove that they are a fan of the performer by being granted the NFT.

### <Hardware Configuration>

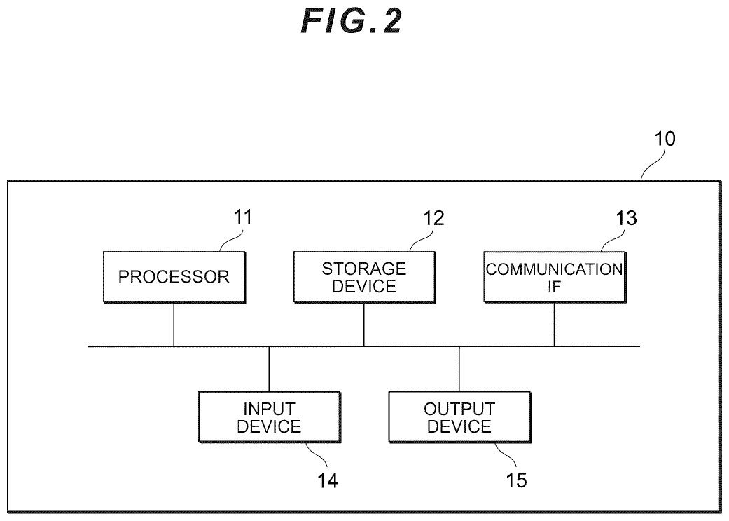

FIG. 2 is a diagram showing an example hardware configuration of the management server 10. The management server 10 includes a processor 11 such as a CPU (Central Processing Unit) and a GPU (Graphics Processing Unit), a storage device 12 such as a memory (e.g., a RAM (Random Access Memory) or a ROM (Read Only Memory)), an HDD (Hard Disk Drive) and/or an SSD (Solid State Drive), a network IF (Network Interface) 13 for wired or wireless communication, an input device 14 for receiving input operations, and an output device 15 for outputting information. The input device 14 is, for example, a keyboard, a touch panel, a mouse, and/or a microphone. The output device 15 is, for example, a display, a touch panel, and/or a speaker.

### <Functional Block Configuration>

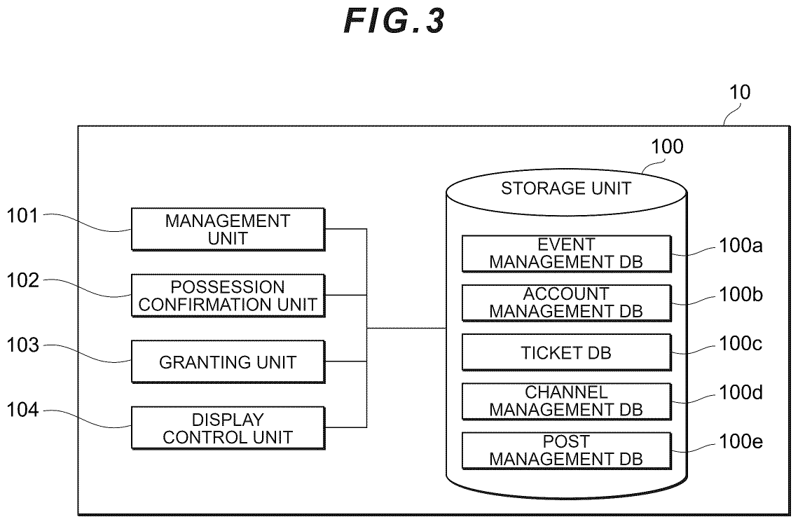

FIG. 3 is a diagram showing an example functional block configuration of the management server 10. The management server 10 includes a storage unit 100, a management unit 101, a possession confirmation unit 102, a granting unit 103, and a display control unit 104. The storage unit 100 can be implemented using the storage device 12 included in the management server 10. Further, the management unit 101, the possession confirmation unit 102, the granting unit 103, and the display control unit 104 can be implemented by the processor 11 of the management server 10 executing a program stored in the storage device 12. Further, the program can be stored on a storage medium. The storage medium storing the program may be a non-transitory computer-readable storage medium. The non-transitory storage medium is not particularly limited, but may be, for example, a storage medium such as a USB (Universal Serial Bus) memory or a CD-ROM (Compact Disc Read-Only Memory).

The storage unit 100 stores an event management DB 100a that stores information on held events (event holding information), an account management DB 100b that manages accounts for accessing websites provided by the management server 10, and a ticket management DB 100c that manages information on tickets possessed by general users, a channel management DB 100d that manages information on channels being opened and a post management DB 100e that stores data posted to channels (e.g., text, image data and video data).

The management unit 101 manages a channel that is a communication tool opened for each performer and each event. Specifically, the management unit 101 manages posting to the channels and viewing of posts to the channels. Further, upon accepting posting to a channel, the management unit 101 stores the posted post data in the post management DB 100e. Further, upon accepting viewing of post data posted to a channel, the management unit 101 acquires the post data from the post management DB 100e and displays it on the screen of the terminal 20.

Further, when accepting posting to a channel and viewing of posts to a channel, the management unit 101 checks the presence/absence of the authority. For example, the management unit 101 permits ticket possessing users who have been confirmed to possess a ticket for an event and the performer of the event to make a post to the channel and view posts to the channel.

The possession confirmation unit 102 acquires ticket information related to a ticket for an event possessed by a user who participates in the event, and compares the acquired ticket information with the event holding information, so as to confirm that the user possesses the ticket.

The granting unit 103 instructs the smart contract operating on the blockchain network 30 to issue an NFT indicating participation in the event. Further, the granting unit 103 grants an NFT including information on participation in the event (e.g., the event name, the event date and time, and the performer's name) to a blockchain wallet of a ticket possessing user who has been determined to possess a ticket for the event. Further, the granting unit 103 grants an image of a badge to the ticket possessing user as information on participation in the event. The image of the badge may be called an icon.

The display control unit 104 displays various screens for implementing the communication service on the terminal 20. Note that the display control unit 104 may be included in the management unit 101.

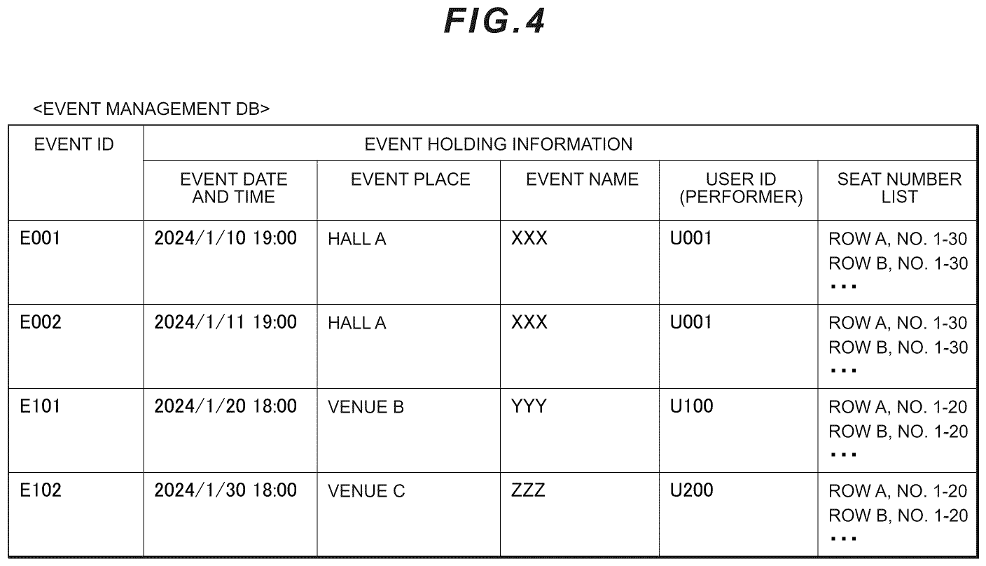

FIG. 4 is a diagram showing an example of the event management DB 100a. The event ID indicates an ID that uniquely identifies a held event. The event holding information includes identifying information that uniquely identifies the held event. The event date and time indicates the date on which the event is held and the event start time. The event place indicates the place where the event is held. The event name indicates the name of the event. The performer ID indicates an ID that uniquely identifies the performer. Note that the performer ID may further include the performer's name corresponding to the performer ID. The seat number list indicates information on all seat numbers provided in the event venue (e.g., there are seat numbers 1-30 for each of rows A-F).

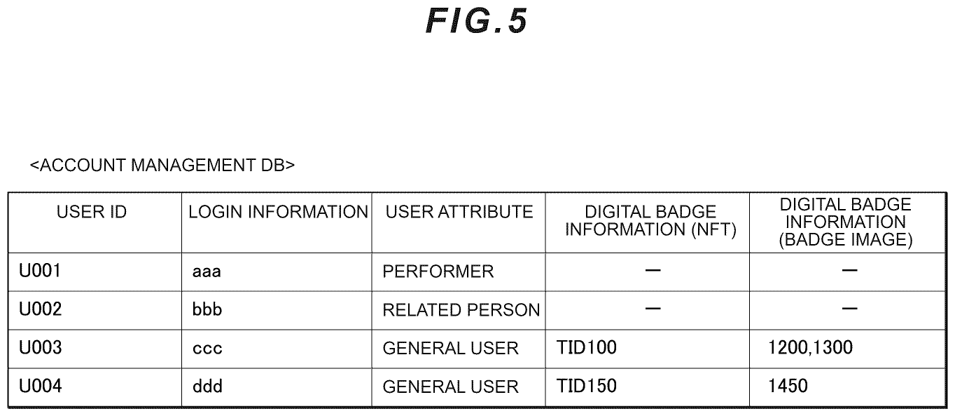

FIG. 5 is a diagram showing an example of the account management DB 100b. The user ID indicates an ID that uniquely identifies a user registered in the communication service. The login information indicates login information (e.g., a login ID and a password) for logging in to the communication service. The user attribute indicates the attribute of the user (one of a performer, a related person, and a general user). When an NFT indicating participation in an event is granted to a general user, the token ID of the granted NFT is stored in the digital badge information (NFT). If the NFT is not granted, nothing is stored in the digital badge information (NFT). An ID of an image of a badge indicating which event the general user participated in is stored in the digital badge information (badge image). The image of the badge is displayed in the screen of the communication service in association with the general user. If the badge is not granted, nothing is stored in the digital badge information (badge image).

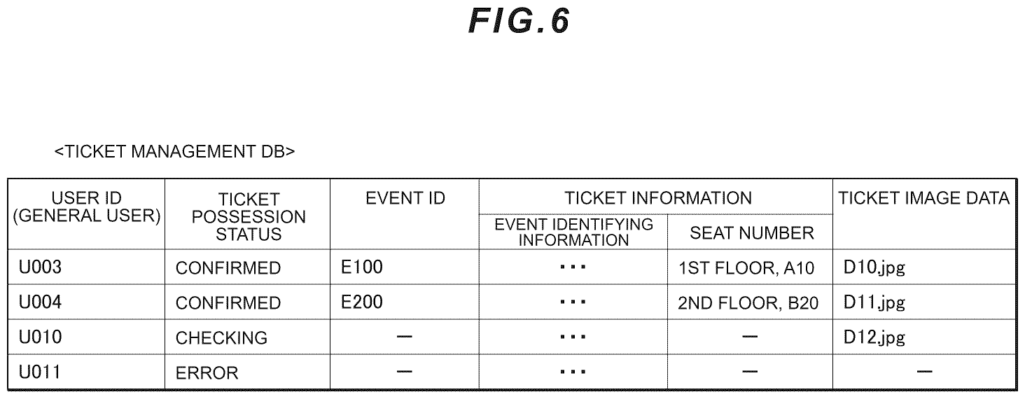

FIG. 6 is a diagram showing an example of the ticket management DB 100c. The user ID (general user) indicates an ID that uniquely identifies a general user. The ticket possession status indicates whether or not the general user has been confirmed to possess a ticket. “Confirmed” indicates the status in which the general user has been confirmed to possess a ticket. “Checking” indicates that it is being checked that the general user possesses a ticket, for example, when uploaded image data of the ticket is being parsed, or when the administrator is checking it. “Error” indicates that it cannot be confirmed that the general user possesses a ticket. The event ID indicates an event ID identified from event identifying information described later. Various types of information on the ticket possessed by the user is stored in the ticket information. The event identifying information indicates event identifying information that uniquely identifies the event that is read from the ticket image data. The specific content of the event identifying information will be described later. The seat number indicates the seat number written on the ticket. The image data uploaded to the management server 10 is stored in the ticket image data.

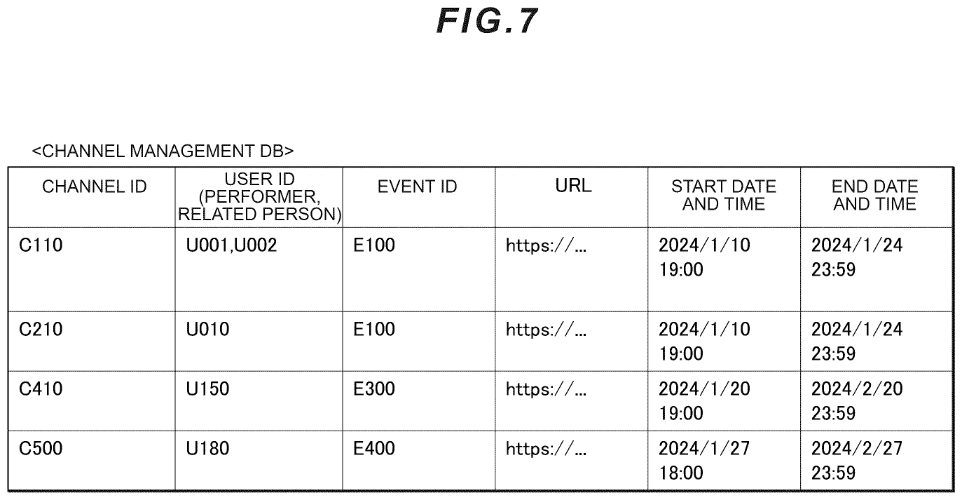

FIG. 7 is a diagram showing an example of the channel management DB 100d. The channel ID indicates an ID that uniquely identifies an opened channel. The user ID (performer, related person) indicates IDs that uniquely identify a performer and a related person among the users registered in the communication management system 1. The event ID indicates an ID that uniquely identifies an event. The URL indicates a URL for accessing the opened channel. The start date and time indicates the date and time when the opening of the channel is started. The end date and time indicates the date and time when the opening of the channel ends (is closed). Note that in the case of an event in which a plurality of performers appear, a channel may be opened for each performer, or may be opened for the plurality of performers in common. In the former case, a plurality of different channel IDs are associated with the same event ID. On the other hand, in the latter case, one channel ID is associated with the same event ID.

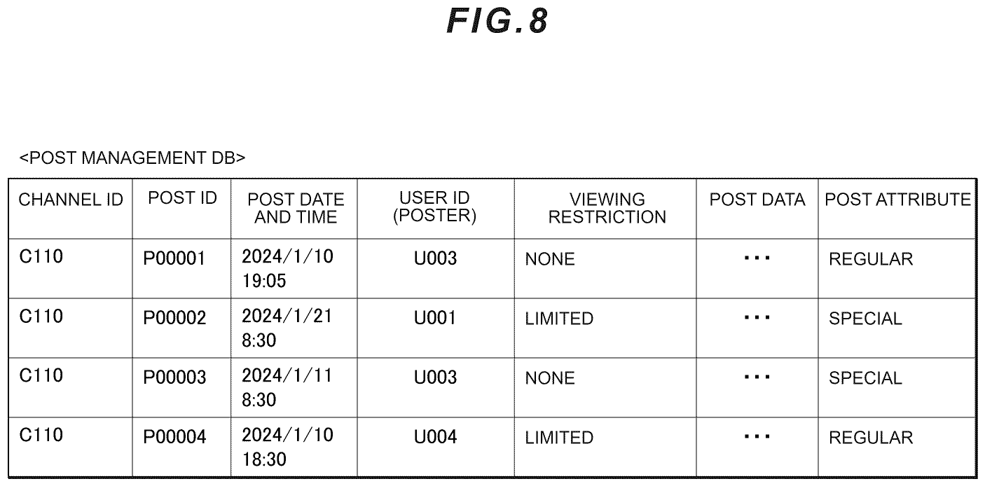

FIG. 8 is a diagram showing an example of the post management DB 100e. The channel ID indicates an ID that uniquely identifies an opened channel. The post ID indicates an ID that uniquely identifies post data. The post date and time indicates the date and time when the post data is posted to the channel. The ID of the user who posts the post data to the channel is stored in the user ID (poster). For example, when a performer makes a post, the user ID of the performer is stored in the poster ID. Further, when a ticket possessing user makes a post, the user ID of the ticket possessing user is stored in the poster ID.

The viewing restriction indicates whether or not viewing of posts is restricted. In the present embodiment, posts to a channel include posts that can be viewed only by limited users (hereinafter referred to as “limited posts”) and posts that are not restricted from being viewed (hereinafter referred to as “regular posts”). When a post is a regular post, “none” is set, and when a post is a limited post, “limited” is set. Posted text data, image data, audio data and/or video data are stored in the post data. Note that the limited users (hereinafter referred to as “limited users”) may be the ticket possessing users and the performer of the event. Alternatively, the limited users may be the ticket possessing users, the performer of the event, and the related persons of the event. That is, “limited users” may be defined as limited users including the ticket possessing users and the performer of the event.

“Post attribute” indicates the attribute of the post. In the present embodiment, posts to a channel may include special posts and non-special posts. A special post may be a message that can be posted by paying money. As an example, a special post may be a message containing an image, audio or video, but is not limited thereto. As another example, a special post may be a post that is displayed preferentially to non-special posts on a screen displaying a list of posts. On the other hand, a non-special post may be a message that can be posted regularly without paying money. As an example, a non-special post may be a text-only message that do not contain an image, audio and video, but is not limited thereto. In the column of “post attribute” for a special post, “special” is stored as the attribute of the post. Further, in the column of “post attribute” for a non-special post, “regular” is stored as the attribute of the post.

Whether a post is special or not is applicable to both a regular post and a limited post. That is, in the present embodiment, posts may be divided into four types: non-special regular posts, non-special limited posts, special regular posts, and special limited posts.

### <Processing Procedure>

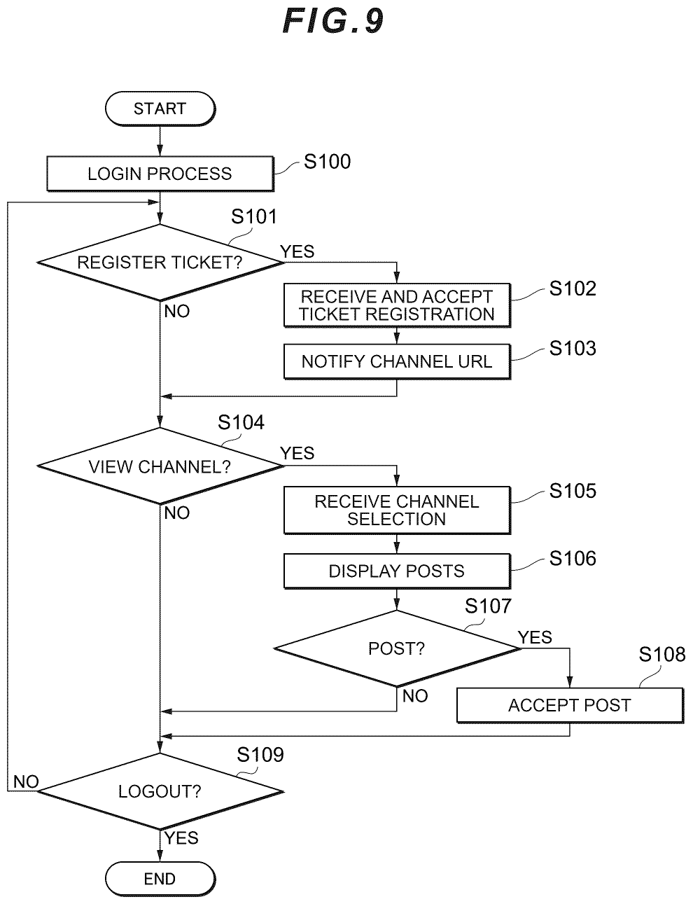

FIG. 9 is a diagram showing an example of a processing procedure performed by the management server 10. Various processes performed on the communication service provided by the management server 10 will be described with reference to FIG. 9.

In step S100, the management unit 101 performs a login process by receiving input of login information from a user who uses the communication service. The management unit 101 performs a login process by comparing the input login ID and password with the account management DB 100b. When the login is completed, the process proceeds to step S101, and when the login fails, the process is terminated.

In step S101, when the logged-in user selects ticket registration by operating the screen, the process proceeds to the processing procedure in step S102. When ticket registration is not selected, the process proceeds to step S104.

In step S102, the possession confirmation unit 102 acquires ticket information from the terminal 20 used by the user, and checks whether the user possesses a ticket or not. Specifically, the user uploads (registers) image data obtained by photographing a paper ticket or a screenshot of an electronic ticket from the terminal 20 to the management server 10. The possession confirmation unit 102 acquires the image data of the ticket possessed by the user. Subsequently, the possession confirmation unit 102 reads the characters written on the ticket by performing OCR (Optical Character Recognition) processing on the image data of the ticket, and extracts ticket information by performing named entity recognition processing on the read character string. Note that instead of performing OCR processing on the image data, the possession confirmation unit 102 may extract ticket information using a learning model trained to output ticket information when image data of a ticket is input. Further, the administrator of the communication service may visually read the ticket information. In this case, the possession confirmation unit 102 may receive input of the visually read ticket information from the administrator of the communication service.

Further, when it is possible to purchase a ticket in the communication service, that is, when the management server 10 issues a ticket by itself, the possession confirmation unit 102 may acquire ticket information related to the ticket possessed by the user from the database that manages information on the issued ticket.

Further, when it is possible to acquire purchase data for a ticket from another server that manages sale and purchase information for tickets (e.g., a server of a ticket agency operated by another company), the possession confirmation unit 102 may acquire ticket information for the ticket possessed by the user from the other server that manages information on the issued ticket.

Subsequently, the possession confirmation unit 102 compares the event identifying information that uniquely identifies the event included in the ticket information read from the image data with the event holding information included in the event management DB 100a, and when the event identifying information coincides with the identifying information included in the event holding information (i.e., when the event can be uniquely identified), it determines that the user has been confirmed to possess a ticket for the event.

On the other hand, when the event identifying information does not coincide with the identifying information included in the event holding information (i.e., when the event cannot be uniquely identified), the possession confirmation unit 102 may determine that the user could not be confirmed to possess a ticket for the event. In this case, the possession confirmation unit 102 may further request the administrator of the communication service to visually check the image data of the ticket. When receiving a notification from the administrator that the user possesses a ticket for the event, the possession confirmation unit 102 determines that the user has been confirmed to possess a ticket for the event.

Further, for a ticket possessing user who has been confirmed to possess a ticket, the possession confirmation unit 102 acquires the event ID corresponding to the ticket from the event management DB 100a. Subsequently, the management unit 101 stores the acquired event ID, the event identifying information, and the seat number of the ticket in a record for the ticket possessing user in the ticket management DB 100c.

The event identifying information read from the ticket image data and the identifying information included in the event holding information in the event management DB 100a may be, for example, the event date and time, the event place, and/or the event name. For example, when the event identifying information (the event date and time, the event place, and the event name) read from the image data of the ticket coincides with the identifying information (the event date and time, the event place, and the event name) included in the event holding information in the event management DB 100a, the possession confirmation unit 102 may determine that the user has been confirmed to possess a ticket for the event. Further, for example, when the event identifying information (the event date and time and the event name) read from the image data of the ticket coincides with the identifying information (the event date and time and the event name) included in the event holding information in the event management DB 100a, the possession confirmation unit 102 may determine that the user has been confirmed to possess a ticket for the event. Further, for example, when the event identifying information (the event name) read from the image data of the ticket coincides with the identifying information (the event name) included in the event holding information in the event management DB 100a, the possession confirmation unit 102 may determine that the user has been confirmed to possess a ticket for the event.

Further, the event identifying information and the identifying information included in the event holding information may further include the performer. For example, when the performer's name read from the image data of the ticket is included in the performers included in the event holding information in the event management DB 100a, the possession confirmation unit 102 may further determine that the user has been confirmed to possess a ticket for the event.

Further, the event identifying information and the identifying information included in the event holding information may further include a seat number. For example, when the seat number read from the image data of the ticket is included in the seat number list included in the event holding information in the event management DB 100a, the possession confirmation unit 102 may further determine that the user has been confirmed to possess a ticket for the event. This makes it possible to exclude fraudulent tickets on which a non-existent seat number is written.

Note that when tickets are sold within the communication service, it is possible to write the event ID on a ticket. Therefore, when an event ID is written on a ticket, the event identifying information and the identifying information included in the event holding information may be the event ID. In this case, when the event identifying information (the event ID) read from the image data of the ticket coincides with the identifying information (the event ID) included in the event holding information in the event management DB 100a, the possession confirmation unit 102 may determine that the user has confirmed to possess a ticket for the event.

Further, when tickets are sold in the communication service, or when it is possible to acquire purchase data for a ticket from another server that manages sale and purchase information for tickets, the possession confirmation unit 102 may deem that the user possesses a ticket, omit the processing procedure in step S102, and proceed to the processing procedure in step S103.

Here, the possession confirmation unit 102 may further confirm that the uploaded ticket is not an already registered ticket by using the seat information of the ticket. Further, when it can be confirmed that the uploaded ticket is not an already registered ticket, the possession confirmation unit 102 may determine that the user possesses a ticket for the event.

Specifically, the seat information included in the ticket information that uniquely identifies the seat in the event is not the same as seat information identified from image data of tickets acquired from other users (i.e., when the seat information is not duplicated), the possession confirmation unit 102 may further determine that the user possesses a ticket for the event. Further, when the seat information included in the ticket information that uniquely identifies the seat in the event is the same as seat information specified from image data of tickets acquired from other users (i.e., when the seat information is duplicated), the possession confirmation unit 102 may determine that the user does not possess a ticket for the event. This makes it possible to prevent duplicate registration of the same ticket by a plurality of users.

In step S103, for a ticket possessing user who has been confirmed to possess a ticket in the processing procedure in step S102, the management unit 101 acquires the event ID corresponding to the ticket possessed by the ticket possessing user from the ticket management DB 100c. Subsequently, the management unit 101 accesses the channel management DB 100d to acquire the URL of the channel corresponding to the event ID, and transmits the acquired URL to the terminal 20 of the ticket possessing user. Note that when a plurality of channels are opened for the same event, the management unit 101 acquires a plurality of URLs. For example, in the example in FIG. 7, when the event ID is E100, the management unit 101 acquires two URLs: the URL of the channel having a channel ID of C110 and the URL of the channel having a channel ID of C210. Subsequently, the management unit 101 transmits the acquired URLs to the terminal 20 of the ticket possessing user. When a plurality of URLs are acquired, the management unit 101 transmits the plurality of URLs to the terminal 20 of the ticket possessing user.

Note that in addition to or instead of transmitting the URLs to the terminal 20, the management unit 101 may display a channel list screen that displays a list of channels corresponding to the ticket possessed by the user on the terminal 20.

In step S104, when the user selects viewing of a channel, that is, when a URL is accessed, or when a channel is selected from the channel list screen, the management unit 101 proceeds to the processing procedure in step S105. When the user does not select viewing of a channel, the process proceeds to the processing procedure in step S109.

In step S105, the management unit 101 receives the selection of a channel the user wants to view from the user. For example, when the user accesses a URL, the management unit 101 may recognize that the channel of the URL has been selected. Alternatively, the management unit 101 may receive the selection of a channel the user wants to view from within the channel list screen. Note that when the user accesses the URL of a channel that has not been started or has ended, the management unit 101 may display a message indicating that the accessed channel has not been started or has ended on the screen of the terminal 20.

In step S106, the management unit 101 displays posted messages posted to the selected channel on the screen of the terminal 20. Specifically, the management unit 101 acquires post data and setting values for viewing restriction in the channel selected in step S105 from the post management DB 100e. Subsequently, the management unit 101 displays a list of post data on the screen of the terminal 20.

Here, the management unit 101 may permit a limited user for the channel to be viewed to view regular posts and limited posts. Further, the management unit 101 may permit a user other than the limited users for the channel to be viewed (i.e., a ticket non-possessing user) to view regular posts, and may not permit them to view limited posts.

When displaying a list of post data on the screen of the terminal 20, the management unit 101 accesses the channel management DB 100d to acquire the event ID of the channel to be viewed and the user ID of the performer. Subsequently, the management unit 101 checks the attributes of the user by referring to the account management DB 100b.

When the attribute of the user is a “general user”, the management unit 101 further checks whether the general user is a ticket possessing user or a ticket non-possessing user in the channel to be viewed by referring to the “ticket possession status” in the ticket management DB 100c. For example, for a record of the event ID of the channel to be viewed, the management unit 101 may determine that a general user whose “ticket possession status” is “confirmed” is a ticket possessing user and a general user whose “ticket possession status” is “checking” or “error” is a ticket non-possessing user. Further, a general user for which there is no record that matches the event ID of the channel to be viewed and the user ID in the ticket management DB 100c may be determined to be a ticket non-possessing user.

Further, when the attribute of the user is a “performer” or a “related person”, the management unit 101 checks whether or not the user ID of the user is included in the “user IDs (performer, related person)” in the channel to be viewed by referring to the channel management DB 100d. When it is included, the user is determined to be a performer or a related person in the channel to be viewed, and when it is not included, the user is determined not to be a performer and related person in the channel to be viewed. In the latter case, the management unit 101 may treat the user as a ticket non-possessing user in the channel to be viewed.

Subsequently, the management unit 101 acquires post data and setting values for viewing restriction in the channel to be viewed from the post management DB 100e. Subsequently, when the user is a “performer”, a “related person”, and a “ticket possessing user” in the channel to be viewed, the management unit 101 displays post data for which the viewing restriction is set to “none” and “limited” among the posts to the channel to be viewed on the screen of the terminal 20. On the other hand, when the user is a “ticket non-possessing user” in the channel to be viewed, the management unit 101 displays post data for which the viewing restriction is set to “none” among the posts to the channel to be viewed on the screen of the terminal 20, and does not display post data for which the viewing restriction is set to “limited” on the screen of the terminal 20. Note that the management unit 101 may display post data for which the viewing restriction is set to “limited” on the screen of the terminal 20 in a form in which it is possible to recognize the existence of the post data but it is impossible to view or output the post data itself (e.g., the text or images are masked).

Further, the management unit 101 may permit limited users and users other than the limited users (i.e., all users) in the channel to be viewed to view non-special regular posts and special regular posts.

In step S107, when the user selects posting of a message by operating the screen, the management unit 101 proceeds to the processing procedure in step S108. When posting of a message is not selected, the process proceeds to step S109.

In step S108, the management unit 101 accepts a post from the user. The management unit 101 stores post data acquired from the terminal 20 of the user and the user ID of the user (poster) in the post management DB in association with each other.

Here, the management unit 101 permits a limited user in the channel to be viewed (which may be called the posting target channel) to make a new regular post and a new limited post to the channel to be viewed. On the other hand, the management unit 101 may not permit a user (a ticket non-possessing user) other than the limited users in the channel to be viewed to make either a regular post or a limited post to the channel to be viewed.

The management unit 101 checks the attribute of the logged-in user by referring to the account management DB 100b. Further, when the attribute of the user is a general user, the management unit 101 checks whether the user is a ticket possessing user or a ticket non-possessing user in the channel to be viewed by referring to the ticket management DB 100c. Subsequently, when the user is a performer, a related person, and a ticket possessing user in the channel to be viewed (i.e., a limited user), the management unit 101 receives selection of whether to make a limited post or a regular post from the user, and stores the received setting for viewing restriction and post data in the post management DB 100e in association with each other. On the other hand, when the user is a ticket non-possessing user in the channel to be viewed (i.e., a user other than the limited users), the management unit 101 does not accept posts.

Further, when the user is a performer, a related person, and a ticket possessing user in the channel to be viewed (i.e., a limited user), the management unit 101 may accept making non-special regular posts, special regular posts, non-special limited posts, or special limited posts. The management unit 101 stores the setting for viewing restriction, the setting for the post attribute, and the post data in the post management DB 100e in association with each another.

Further, the management unit 101 may permit a ticket non-possessing user in the channel to be viewed to make a regular post to the channel, but not permit them to make a limited post. Further, the management unit 101 may further permit a ticket non-possessing user in the channel to be viewed to make a non-special regular post, but may not permit them to make a special regular post.

In step S109, the management unit 101 ends the process when the user selects logout, and returns to step S101 when the user does not select logout.

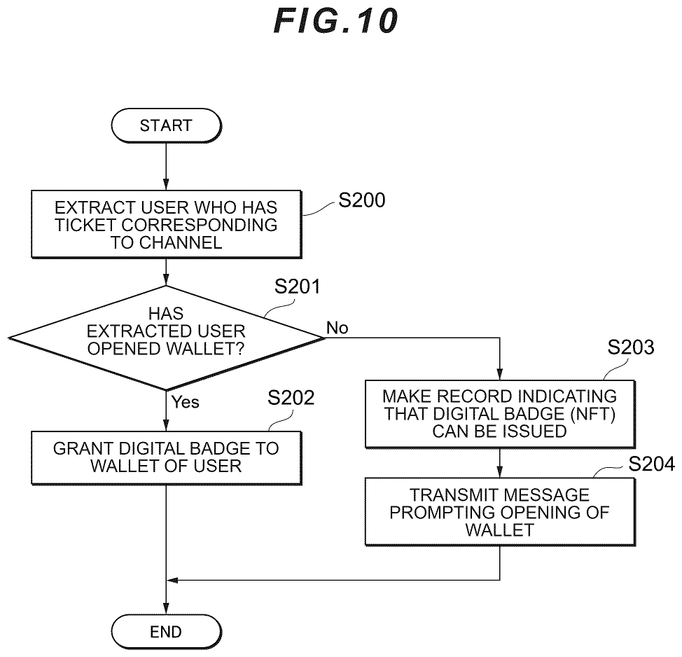

FIG. 10 is a diagram showing an example of a processing procedure performed by the management server 10. A processing procedure when the management server 10 grants a badge indicating participation in an event to a ticket possessing user will be described with reference to FIG. 10. Note that the timing of executing the processing procedure in FIG. 10 may be determined freely, for example, it may be executed when the channel is closed, or it may be executed between the end of the event and the closing of the channel. The following description is provided assuming that a badge is granted when the channel is closed.

In step S200, the granting unit 103 extracts a user who possesses a ticket corresponding to a closed channel. Specifically, the granting unit 103 acquires the event ID corresponding to the closed channel by referring to the channel management DB 100d. Subsequently, the granting unit 103 extracts a user whose “ticket possession status” corresponding to the acquired event ID is “confirmed” by referring to the ticket management DB 100c.

In step S201, the granting unit 103 checks whether or not the extracted ticket possessing user has opened a blockchain wallet. For example, the granting unit 103 may display a screen for entering the address of the blockchain wallet on the terminal 20 of the extracted ticket possessing user. When the ticket possessing user enters the wallet address, the granting unit 103 determines that the ticket possessing user has opened a wallet and proceeds to step S202, and when the ticket possessing user selects non-possession of a wallet address, the granting unit 103 determines that the ticket possessing user has not opened a wallet and proceeds to step S203. Alternatively, the granting unit 103 may check whether or not the extracted ticket possessing user has opened a blockchain wallet by referring to whether or not a wallet address is registered in the account management DB 100b.

In step S202, the granting unit 103 grants an NFT including information on participation in the event to the blockchain wallet of the ticket possessing user. Specifically, the granting unit 103 generates an NFT by issuing a method for issuing an NFT to the smart contract on the blockchain network 30, and stores the token ID of the generated NFT in the digital badge information (NFT) of the record for the ticket possessing user in the account management DB 100b. Further, the granting unit 103 grants a badge image to the ticket possessing user. Specifically, the granting unit 103 stores an image ID corresponding to the badge image in the “digital badge information (badge image)” of the record for the ticket possessing user in the account management DB 100b.

In step S203, the granting unit 103 makes a record indicating that an NFT can be issued in the “digital badge information (NFT)” of the record for the user by referring to the account management DB 100b. Further, the granting unit 103 grants a badge image to the ticket possessing user. Specifically, the granting unit 103 stores an image ID corresponding to the badge image in the “digital badge information (badge image)” of the record for the ticket possessing user in the account management DB 100b.

In step S204, the granting unit 103 transmits a message prompting the opening of a wallet to the terminal 20 of the user.

### <Example Screen Display>

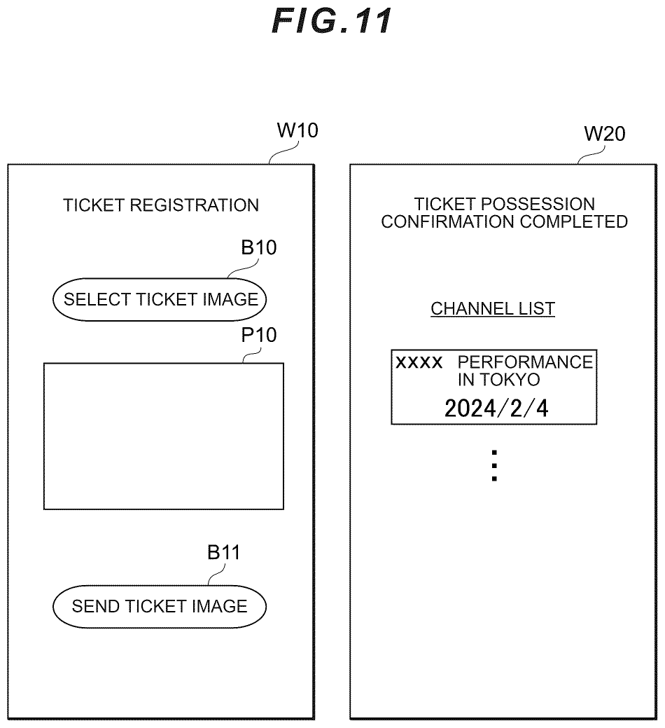

FIG. 11 is a diagram showing an example of screens for registering a ticket. A screen W10 is a screen for receiving registration of a ticket. When B10 is pressed, a screen for selecting an image obtained by photographing a ticket is displayed. A selected ticket image is displayed in an image display area P10. When a send button B11 is pressed, the ticket image is uploaded to the management server 10. When the registration of the ticket is completed and the user is confirmed to possess a ticket, a transition to a screen W20 is made. The screen W20 displays a list of channels for events that can be attended with the registered ticket.

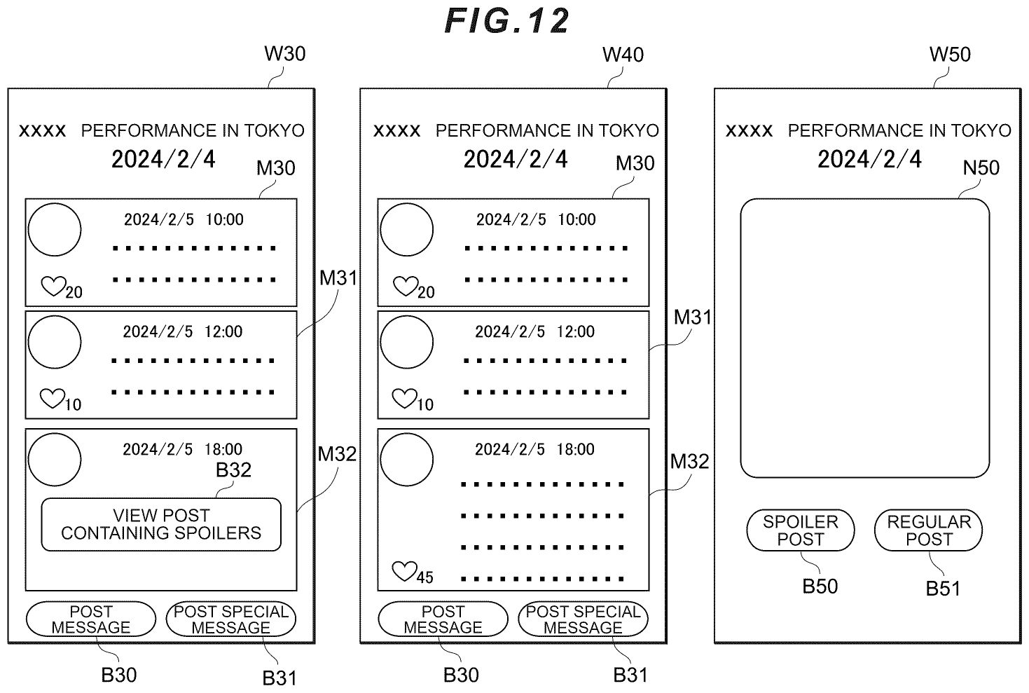

FIG. 12 is a diagram showing an example of post display screens. Posts to a channel selected on the screen W20 in FIG. 11 are displayed in a list on a post display screen W30 in chronological order. Posted messages M30 and M31 are posted messages of regular posts, and a posted message M32 is a posted message of a limited post. Since the posted message M32 is restricted from being viewed, the post content is not displayed. For example, when the user is a ticket possessing user, a performer, and a related person, a button B32 for displaying the message that is restricted from being viewed is displayed on the posted message M32. Further, when the user is a ticket non-possessing user, the button B32 may not be displayed on the message M32, the button B32 may be displayed in a form that cannot be pressed (grayed out), or the content of the posted message M32 may not be displayed even when the button B32 is pressed.

When the button M32 is pressed, the content of the posted message M32 is displayed as shown on a post display screen W40.

Further, when the user is a ticket possessing user, a performer, and a related person, a post message button B30 and a post special message button B31 are displayed on the post display screen W30. On the other hand, when the user is a ticket non-possessing user, the button B30 and the button B31 may not be displayed, the button B30 and the button B31 may be displayed in a form that cannot be pressed (grayed out), or a transition to a posting screen W50 may not be made even when the button B30 and the button B31 are pressed.

When the post message button B30 or the post special message button B31 is pressed, a transition to the posting screen W50 is made. An area N50 for inputting the content to be posted is displayed on the posting screen W50. Further, when the user is a ticket possessing user, a performer, and a related person, a button B50 for posting a message that is restricted from being viewed and a button B51 for posting a message that is not restricted from being viewed are displayed in the posted message M32 on the posting screen W50.

### MODIFICATIONS

### Modification 1

The possession confirmation unit 102 may further confirm that the user possessing a ticket actually participated in the event. Further, a user who possesses a ticket and can be confirmed to have actually participated in the event may be referred to as an “event participating user”, and a user who has not been confirmed to possess a ticket and a user who possesses a ticket but did not participate in the event may be referred to as “event non-participating users”. Further, in the various processes described in the present embodiment, a ticket possessing user and a ticket non-possessing user may be replaced with an event participating user and an event non-participating user, respectively.

In the processing procedure in step S102, the terminal 20 may upload information allowing confirmation of actual participation in the event in addition to the ticket image. Further, the possession confirmation unit 102 may confirm that the user participated in the event by confirming that the information allowing confirmation of actual participation in the event is correct information in addition to the ticket image.

The information allowing confirmation of actual participation in the event may be, for example, information specified in advance for each event venue. Specifically, it may be an image captured from a specified position in a specified direction in the event venue, or it may be an image obtained by photographing a specified object existing in the event venue (e.g., a seating chart or a seat number written on a chair). Further, the information specified in advance for each event venue is stored in the event holding information in the event management DB 100a, and the possession confirmation unit 102 may compare the information uploaded from the terminal 20 with the information specified in advance for each event venue stored in the event holding information, and determines that the user actually participated in the event when both coincide with each other.

### Modification 2

The login process in step S100 may be executed on another server different from the management server 10. For example, in the present embodiment, the login process performed by each user may be implemented using an external SSO (Single Sign On) service. Further, the management unit 101 may transfer login information received from a user who uses the communication service to another server, and acquire a login result (success/failure) from the other server.

### Modification 3

In the present embodiment, duplicate registration of the same ticket by a plurality of users may be prevented by using information that can uniquely identify the ticket instead of the “seat number”. That is, “seat number” in the present embodiment may be read as “information that can uniquely identify the ticket”. Information that can uniquely identify a ticket may consist of, for example, a character string and/or a combination of numbers. Further, information that can uniquely identify the ticket may be a reference number. Note that a reference number is a number different for each ticket written on the ticket, and is used, for example, when specifying the order of entrance when visitors enter the venue.

### Modification 4

In the present embodiment, a wallet may be automatically opened for a user who uses the communication service. For example, in order to create an account for the communication service, it may be mandatory to open a wallet. In this case, the processing procedures in step S200, step S201, step S203 and step S204 in FIG. 10 may be omitted.

### Modification 4

In the present embodiment, “related persons” may be omitted. In this case, there are two types of users who use the communication service: performers and general users.

### SUMMARY

According to the embodiment described above, the management server 10 manages a channel that is a communication tool opened for each performer and each event, and allows users who have been confirmed to possess a ticket for an event and the performer of the event to make posts to the channel and view posts. This enables direct communication between users participating in an event and between the users and the performer.

Further, the management server 10 reads ticket information from image data of a ticket. By reading the ticket information from the image data of the ticket, it is possible to acquire the ticket information even when the medium of the ticket is different for each company issuing the ticket. For example, when the ticket is a paper medium, the management server 10 can read the ticket information from an image obtained by photographing the ticket with a camera provided in the terminal 20. Further, when the ticket is an electronic ticket, the management server 10 can read the ticket information from an image obtained using the screenshot function provided in the terminal 20.

Further, the management server 10 makes it possible to make both regular posts and limited posts to a channel, allows only the limited users (e.g., the performer and the ticket possessing users) to view the limited posts, and restricts users other than the limited users (the ticket non-possessing users) from viewing them. This enables the performer and the ticket possessing users to offer information known only to the performer and users who actually participated in the event, and makes it possible to feel closer to the performer, or enables closer communication between users who participated in the event.

The embodiments described above are intended to facilitate the understanding of the present invention, and are not for interpreting the present invention in a limited manner. The flowcharts and sequences described in the embodiments, elements provided in the embodiments, and their arrangements, materials, conditions, shapes, sizes, and the like are not limited to those illustrated, but can be changed as appropriate. Further, it is possible to partially replace or combine the configurations shown in different embodiments.

### REFERENCE SINGS LIST

1 communication management system
10 management server
11 processor
12 storage device
13 network IF
14 input device
15 output device
20 terminal
30 blockchain network
10 management server
100 storage unit
101 management unit
102 possession confirmation unit
103 granting unit
104 display control unit

1. A management apparatus comprising:
a memory storing a program; and
a processor that, by executing the program stored in the memory, is configured to:
store event holding information related to a held event;
manage a channel that is a communication tool opened for each performer and each event;
acquire ticket information related to a ticket for the event possessed by a user, and compares the acquired ticket information with the event holding information, so as to confirm that the user possesses the ticket; and
permit the user who has been confirmed to possess the ticket for the event and a performer of the event to make a post to the channel and view a post to the channel.

2. The management apparatus according to claim 1, wherein
the event holding information includes identifying information that uniquely identifies the event, and
the processor is configured to:
acquire image data of the ticket possessed by the user,
compare event identifying information that uniquely identifies the event included in the ticket information read from the image data with the event holding information, and
determine that the user possesses a ticket for the event when the event identifying information coincides with the identifying information included in the event holding information.

3. The management apparatus according to claim 2, wherein
the processor is configured to:
determine that the user possesses a ticket for the event when seat information included in the ticket information that uniquely identifies a seat in the event is not the same as the seat information identified from image data of a ticket acquired from another user, and
determine that the user does not possess a ticket for the event when seat information included in the ticket information that uniquely identifies a seat in the event is the same as the seat information identified from image data of a ticket acquired from another user.

4. The management apparatus according to claim 1, wherein
posts to the channel include a limited post that can be viewed only by limited users including a user who has been confirmed to possess a ticket for the event and a performer of the event and a regular post that is not restricted from being viewed, and
the processor is configured to permit the limited users to view the regular post and the limited post, and permits users other than the limited users to view the regular post but does not permit the users to view the limited post.

5. The management apparatus according to claim 4, wherein
the processor is configured to permit the limited users to make a regular post and a limited post to the channel, and not permit the users other than the limited users to make a regular post and a limited post to the channel.

6. The management apparatus according to claim 4, wherein
regular posts to the channel include a special regular post that can be made by the limited users, and
the processor is configured to permit the limited users and the users other than the limited users to view the special regular post.

7. The management apparatus according to claim 6, further comprising
wherein the processor is configured to grant an NFT including information on participation in the event to a blockchain wallet of a user who is determined to possess a ticket for the event.

8. A management method to be performed by a management apparatus, the management method comprising:
a step of storing, in a storage unit, event holding information related to a held event;
a step of managing a channel that is a communication tool opened for each performer and each event; and
a step of acquiring ticket information related to a ticket for the event possessed by a user, and comparing the acquired ticket information with the event holding information, so as to confirm that the user possesses the ticket,
wherein in the step of managing, the user who has been confirmed to possess the ticket for the event and a performer of the event are permitted to make a post to the channel and view a post to the channel.

9. A computer-readable non-transitory medium storing a program for causing a computer to execute:
a step of storing, in a storage unit, event holding information related to a held event;
a step of managing a channel that is a communication tool opened for each performer and each event; and
a step of acquiring ticket information related to a ticket for the event possessed by a user, and comparing the acquired ticket information with the event holding information, so as to confirm that the user possesses the ticket,
wherein in the step of managing, the user who has been confirmed to possess the ticket for the event and a performer of the event are permitted to make a post to the channel and view a post to the channel.
